(19) United States
(12) Patent Application Publication
(10) Pub. No.: US 2025/0265758 A1
(43) Pub. Date: Aug. 21, 2025

(54) AUTOMATED CONVERSION OF COMIC BOOK PANELS TO MOTION-RENDERED GRAPHICS

(71) Applicant: Global Publishing Interactive, Inc., Troy, OH (US)

(72) Inventors: Robert Hoffer, Miami Beach, FL (US); Christopher Carter, Bloomingdale, IL (US); Shaun Rowan, Troy, OH (US)

(21) Appl. No.: 18/581,190

(22) Filed: Feb. 19, 2024

(51) Int. Cl. G06T 13/80; G06T 7/11; G06T 7/194; G06V 10/70; G06V 20/40; G06V 20/70

(52) U.S. Cl. CPC G06T 13/80; G06T 7/11; G06T 7/194; G06V 10/70; G06V 20/41; G06V 20/70; G06T 2207/20084

(57) ABSTRACT

A system and method are provided for generating a moving picture from a graphic narrative. Pages of a graphic narrative (e.g., comic book) are partitioned into panels, which are segmented into image segmented elements and text elements. The segmented elements are applied to a machine learning (ML) method that labels/identifies the segmented elements. Prompts based on the labels are then applied to a second ML model that outputs a moving picture representing one or more of the panels. The prompts can include script information, such as a script, storyboard, or a scene (e.g., keyframes). Thus, the comic book is effectively a movie storyboard that is automatically converted into full-motion rendered graphics by treating each combination of text and graphics as a unique prompt for a generative ML model.

### BACKGROUND

Graphic narratives such as comic books, manga, manhwa, and manhua are increasingly being purchased and consumed in digital formats. These digital formats of graphic narratives can be viewed on dedicated electronic reading devices (i.e., e-readers) or an electronic device (e.g., a smartphone, tablet, laptop, or desktop computer) having software for rendering the digital format of the graphic narrative on a screen of the device.

The digital format provides untapped opportunities to make the user experience more immersive and interactive. However, the current presentation of graphic narratives in digital format is largely the same as for print media and fails to take advantage of advances in other areas of technology such as artificial intelligence (AI) and machine learning (ML). For example, advances in generative AI technologies have opened to door to machine-generated images and machine-generated text.

Accordingly, there is a need for new and improved methods for adapting the digital versions of graphic narratives that take advantage of advancements in technologies to make the user experience more interactive and/or to provide an improved user experience of the digital version of the graphic narrative.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an example of panels arranged in a page of a graphic narrative, in accordance with some embodiments.

FIG. 1B illustrates an example of labels being applied to panels in the graphic narrative, in accordance with some embodiments.

FIG. 2A illustrates an example of a first keyframe representing a story depicted in one or more panels for the graphic narrative, in accordance with some embodiments.

FIG. 2B illustrates an example of a second keyframe representing a story depicted in one or more panels for the graphic narrative, in accordance with some embodiments.

FIG. 2C illustrates an example of a third keyframe representing a story depicted in one or more panels for the graphic narrative, in accordance with some embodiments.

FIG. 2D illustrates an example of a fourth keyframe representing a story depicted in one or more panels for the graphic narrative, in accordance with some embodiments.

FIG. 2E illustrates an example of a fifth keyframe representing a story depicted in one or more panels for the graphic narrative, in accordance with some embodiments.

FIG. 2F illustrates an example of a script representing a story depicted in one or more panels for the graphic narrative, in accordance with some embodiments.

FIG. 3A illustrates an example of a desktop computing device for editing and/or viewing a modified graphic narrative, in accordance with some embodiments.

FIG. 3B illustrates an example of a handheld computing device for viewing the modified graphic narrative, in accordance with some embodiments.

FIG. 4 illustrates an example of a block diagram for a system of generating the modified graphic narrative, in accordance with some embodiments.

FIG. 5 illustrates an example of a flow diagram for a method of generating the modified graphic narrative, in accordance with some embodiments.

FIG. 6 illustrates an example of a block diagram of training a generative adversarial network (GAN), in accordance with some embodiments.

FIG. 7A illustrates an example of a block diagram of a transformer neural, in accordance with some embodiments.

FIG. 7B illustrates an example of a block diagram of an encode block of the transformer neural, in accordance with some embodiments.

FIG. 7C illustrates an example of a block diagram of an decode block of the transformer neural, in accordance with some embodiments.

FIG. 8A illustrates an example of a block diagram of training an AI processor to segment/identify/modify elements in the graphic narrative, in accordance with some embodiments.

FIG. 8B illustrates an example of a block diagram for using a trained AI processor to segment/identify/modify elements in the graphic narrative, in accordance with some embodiments.

FIG. 9 illustrates an example of a block diagram of a computing device, in accordance with some embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### OVERVIEW

In one aspect, a method is provided for generating a moving picture from a graphic narrative (e.g., a comic book). The method includes partitioning one or more pages of a graphic narrative into panels; and segmenting one or more panels of the panels into segmented elements comprising one or more image segments and one or more text segments.

The method further includes applying the segmented elements to a first machine learning (ML) method to determine labels of the segmented elements; generating prompts from the labels, the image segments, and the text segments, the prompts representing script information, storyboard information, or scene information corresponding to the one or more panels; and applying the first prompts to a second ML model, and, in response to the prompts, the second ML model outputs a moving picture representing the one or more panels.

In another aspect, the method may also include displaying, on a display of a user device, the moving picture in the one or more panels of a digital version of the graphic narrative.

In another aspect, the method may also include that the prompts include an instruction to render the moving picture as either a live-action moving picture or as an animated moving picture of a specified animation style, the second ML model outputs the moving picture as the live-action moving picture when the instruction is to render the moving picture as the live-action moving picture, and the second ML model outputs the moving picture as the animated moving picture of the specified animation style when the instruction is to render the moving picture as the animated moving picture.

In another aspect, the method may also include that the labels of the image segments include image information comprising: indicia of which of the image segments are fore ground elements and background elements, indicia for how one or more of the image segments move, and/or indicia of textures and/or light reflection of one or more of the image segments. Further, the method also includes that the labels of the text segments include text information comprising: indicia of whether one or more of the text segments are dialogue, character thoughts, sounds, or narration, and/or indicia of a source/origin of the one or more of the text segments. The method further includes that the prompts include one or more keyframing instructions and one or more stage commands based on the image information and the text information.

In another aspect, the method may also include that the one or more keyframing instructions comprise: (i) an instruction directing the generation of keyframes at intervals throughout the moving picture, wherein the keyframes include at least positions of the image segments in a starting frame and position of the image segments in a concluding frame; (ii) an instruction regarding how the one or more of the foreground elements move between the keyframes; and/or (iii) an instruction regarding how the one or more of the background elements move between the keyframes. The method further includes that one or more stage commands comprise: (i) an instruction directing a pace of the moving picture; (ii) a script of dialogue between one or more characters of the moving picture; (iii) an instruction regarding emotions emoted by the one or more characters; (iv) an instruction regarding a tome/mood conveyed by the moving picture; and/or (v) an instruction regarding one or more plot devices to apply in the moving picture.

In another aspect, the method may also include that the labels comprise: first text labels indicating which of the text segments include onomatopoeia, narration, or dialogue, second text labels indicating, for respective dialogue segments of the text segments, a source of a dialogue segment and a tone of the dialogue segment; and/or first image labels indicating, for respective characters of the image segments, a name of a character represented in a character image segment.

In another aspect, the method may also include generating global information of the graphic narrative based on applying the panels to a third ML model, wherein the global information comprises plot information, genre information, and atmospheric information . . .

In another aspect, the method may also include that the plot information comprises a type of plot; plot elements associated with respective portions of the panels; and pacing information associated with the respective portions of the panels; the genre information comprises a genre of the graphic narrative; and the atmospheric information comprises settings and atmospheres associated with the respective portions of the panels.

In another aspect, the method may also include that the type of the plot comprises one or more of an overcoming-the-monster plot; a rags-to-riches plot; a quest plot; a voyage-and-return plot; a comedy plot; a tragedy plot; or a rebirth plot; and the plot elements comprise two or more of exposition, a conflict, rising action, falling action, and a resolution. The method further includes that the genre comprises one or more of an action genre; an adventure genre; a comedy genre; a crime and mystery genre; a procedural genre, a death game genre; a drama genre; a fantasy genre; a historical genre; a horror genre; a mystery genre; a romance genre; a satire genre, a science fiction genre; a superhero genre; a cyberpunk genre; a speculative genre; a thriller genre; or a western genre. The method further includes that the settings comprise one or more of an urban setting, a rural setting, a nature setting, a haunted setting, a war setting, an outer-space setting, a fantasy setting, a hospital setting, an educational setting, a festival setting, a historical setting, a forest, a dessert, a beach, a water setting, a travel setting, or an amusement-park setting. The method further includes that the atmospheres comprise one or more of a reflective atmosphere; a gloomy atmosphere; a humorous atmosphere; a melancholy atmosphere; an idyllic atmosphere; a whimsical atmosphere; a romantic atmosphere; a mysterious atmosphere; an ominous atmosphere; a calm atmosphere; a lighthearted atmosphere; a hopeful atmosphere; an angry atmosphere; a fearful atmosphere; a tense atmosphere; or a lonely atmosphere.

In another aspect, the method may also include segmenting, for each respective panel of the panels, a respective panel into respective elements comprising image segments and text segments; applying the respective elements of the respective panels to a third ML model to predict a narrative flow, the narrative flow comprising an order in which the panels are to be viewed; and assigning, in accordance with the narrative flow, index values to the respective panels, the index values representing positions in an ordered list that corresponds to the narrative flow.

In another aspect, the method may also include generating, based on the respective elements, additional prompts corresponding to the respective panels; applying the additional prompts to the second ML model and in response outputting additional moving pictures corresponding to the respective panels; and integrating, based on the narrative flow, the moving picture with the additional moving pictures to generate a film of the graphic narrative.

In another aspect, the method may also include that the first ML model uses information from neighboring frames of the one or more frames to provide continuity and/or coherence between the moving picture of the frame and moving pictures of the neighboring frames.

In another aspect, the method may also include that determining the prompt of the frame is based on local information derived from the frame and global information based on an entirety of the graphic narrative.

In another aspect, the method may also include ingesting the graphic narrative; slicing the graphic narrative into respective pages and determining an order of the pages; applying information of panels on a given page to a third ML model to predict a page flow among the panels of the given page, the predicted page flow comprising an order in which the panels are to be viewed; determining a narrative flow based on the order of the pages and the page flow, wherein panels on a page earlier in the order of the pages occur earlier in the narrative flow than panels on a page that is later in the order of the pages; and displaying, on a display of a user device, the panels according to the predicted order in which the panels are to be viewed, wherein the moving picture is displayed in association with the one or more panels.

In another aspect, the method may also include generating a title sequence of the graphic narrative, wherein the title sequence is a moving picture, and the title sequence is generated based on parsing text segments on a title page and printing page of the graphic narrative, and determining therefrom contributor and contributions ascribed to the respective contributors.

In another aspect, the model may also include that segmenting the one or more panels into the segmented elements is performed using a semantic segmentation that is selected from the group consisting of a Fully Convolutional Network (FCN) model, a U-Net model, a SegNet model, a Pyramid Scene Parsing Network (PSPNet) model, a DeepLab model, a Mask R-CNN, an Object Detection and Segmentation model, a fast R-CNN model, a faster R-CNN model, a You Only Look Once (YOLO) model, a fast R-CNN model, a PASCAL VOC model, a COCO model, a ILSVRC model, a Single Shot Detection (SSD) model, a Single Shot MultiBox Detector model, and a Vision Transformer, ViT) model.

In another aspect, the model may also include that the first ML model used for determining the labels of the segmented elements includes an image classifier and a language model; the image classifier is selected from the group consisting of a K-means model, an Iterative Self-Organizing Data Analysis Technique (ISODATA) model, a YOLO model. A ResNet model, a ViT model, a Contrastive Language-Image Pre-Training (CLIP) model, a convolutional neural network (CNN) model, a MobileNet model, and an EfficientNet model; and the language model is selected from the group consisting of a transformer model, a Generative pre-trained transformers (GPT), a Bidirectional Encoder Representations from Transformers (BERT) model, and a T5 model.

In another aspect, the method may also include that the second ML model used for outputting the moving picture representing the one or more panels includes an art generation model selected from the group consisting of a generative adversarial network (GAN) model; a Stable Diffusion model; a DALL-E Model; a Craiyon model; a Deep AI model; a Runaway AI model; a Colossyan AI model; a DeepBrain AI model; a Synthesia.io model; a Flexiclip model; a Pictory model; a In Video.io model; a Lumen5 model; and a Designs.ai Videomaker model.

In one aspect, a computing apparatus includes a processor. The computing apparatus also includes a memory storing instructions that, when executed by the processor, configure the apparatus to perform the respective steps of any one of the aspects of the above-recited methods.

In one aspect, a computing apparatus includes a processor. The computing apparatus also includes a memory storing instructions that, when executed by the processor, configure the apparatus to partition one or more pages of a graphic narrative into panels; segment one or more panels of the panels into segmented elements comprising one or more image segments and one or more text segments; apply the segmented elements to a first machine learning (ML) method to determine labels of the segmented elements; generate prompts from the labels, the image segments, and the text segments, the prompts representing script information, storyboard information, or scene information corresponding to the one or more panels; and apply the first prompts to a second ML model, and, in response to the prompts, the second ML model outputs a moving picture representing the one or more panels.

In another aspect, the computing apparatus may also include that the labels of the image segments include image information comprising: indicia of which of the image segments are foreground elements and background elements, indicia for how one or more of the image segments move, and/or indicia of textures and/or light reflection of one or more of the image segments. The computing apparatus further includes that the labels of the text segments include text information comprising: indicia of whether one or more of the text segments are dialogue, character thoughts, sounds, or narration, and/or indicia of a source/origin of the one or more of the text segments. The computing apparatus further includes that the prompts include one or more keyframing instructions and one or more stage commands based on the image information and the text information.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art to more efficiently convert print versions of graphic narratives to digital versions of graphic narratives, for example by using machine learning (ML) and artificial intelligence (AI) tools to use the comic book or other graphic narrative (e.g., manga, manhwa, and manhua) as a storyboard from which an ML model generates moving pictures that respectively convey the story in one or more panels of the graphic narrative. The moving pictures can be stitched together to provide a moving-picture film (e.g., a feature film or an episode in the series). Additionally or alternatively, the moving pictures can be integrated into a digital version of the graphic narrative, such that the moving pictures can be respectively shown in corresponding panels of the digital version of the graphic narrative.

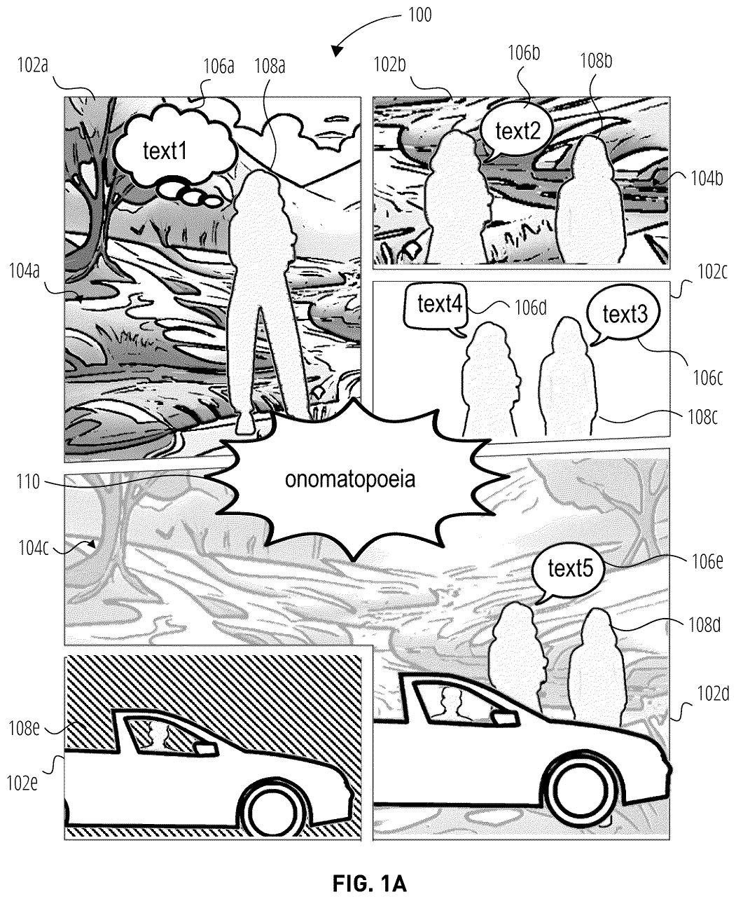

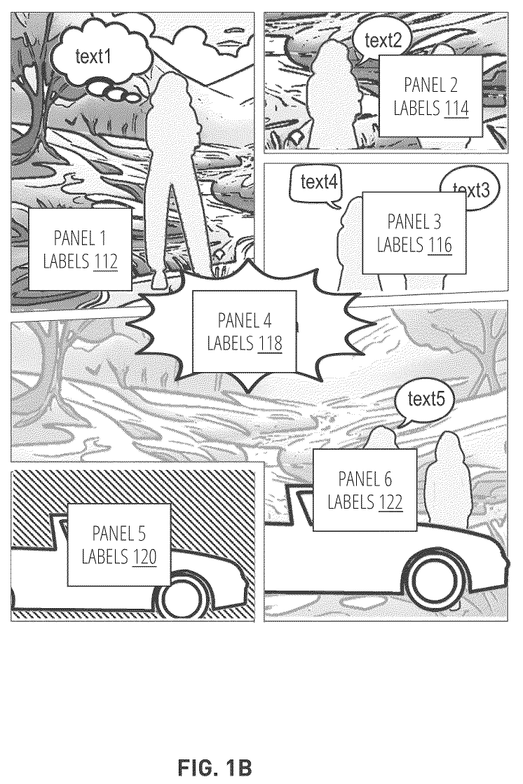

FIG. 1A illustrates a page 100 from a graphic narrative (e.g., a comic book, manga, manhwa, manhua, anime, animated moving picture, etc.). The page 100 includes five panels (i.e., a first panel 102a, a second panel 102b, a third panel 102c, a fourth panel 102d, and a fifth panel 102e). The respective panels can be segmented into parts, including, e.g., a background, a foreground, and bubbles. These parts can be further subdivided into elements, such as characters, objects, text, signs, etc. For example, the first panel 102a includes the background 104a, the foreground 108a, and the bubble 106a. Similarly, the second panel 102b includes bubble 106b, background 104b, and foreground 108b, and the third panel 102c includes bubble 106c, bubble 106d, and foreground 108c, bubble 106c, and bubble 106b. The fourth panel 102d includes background 104c, bubble 106e, and foreground 108d, The fifth panel 102e includes foreground 108e and background 104c. In between the first panel 102a, third panel 102c, and fourth panel 102d is an exclamation bubble with an onomatopoeia 110.

Page 100 exhibits several features that can be found in comic books. In English-language comic books, the convention is to read the panels left-to-right and top-to-bottom. Generally, AI models can be used to enhance a user's experience and can automate many of the tasks for converting a print-based graphic narrative to a digital version that can be interactive and/or immersive user experience. For example, an AI model can be used to determine a narrative flow for the order in which the panels are to be displayed. Additionally, other AI models can be used to convert the stationary images in the panels of a comic book to moving pictures. Additionally or alternatively, AI models can be used to redraw or modify the content of a comic book in a different style. For example, animated images in the original comic book can be redrawn as live-action moving pictures.

Further, digital images generated using an AI model can be resized and reshaped to accommodate different display media and devices. The AI-generated images can be for a three-dimensional (3D) immersive virtual reality environment or augmented reality environment. The panel size for a digital version of the comic book or graphic narrative can be rendered to be displayed using different viewing software or computer applications. Further, the digital version of the comic book can be rendered to be displayed on screens of different sizes, such as on a smartphone screen, a tablet screen, a display screen for a computer, or a television screen.

The panels in a graphic narrative can provide context clues from which an AI model can interpolate and extrapolate intervening story events, and the AI model can interpolate and/or extrapolate movements of the depicted scenery and characters. For example, the graphic narrative effectively provides a movie storyboard from which an AI generates a moving picture. The moving picture can advance the story from one panel of the graphic narrative to one or more subsequent panels. Additionally or alternatively, the moving pictures corresponding to the respective panels can be stitched together to generate a moving picture film representing an entire story conveyed by the graphic narrative.

For example, an AI model can learn how different types of characters and objects move in motion pictures and can statistically learn various context clues regarding how to apply those movements to the characters and objects identified in the panels of a graphic narrative. Consider, for example, a portion of a superhero graphic narrative representing a fight sequence, in the fight scene, a windup for a punch or kick proceeds certain after-effects from the punch or kick, and the movement of the punch or kick can be based on physical models (e.g., the physics of momentum) and/or learned from training data set that includes moving pictures of various fight scenes. Additionally, certain large language models (LLMs) can predict which text is likely to follow which other text to thereby interpolate or fill out dialog gaps in the graphic narrative. Thus, a combination of the relative locations of the panels, the image elements represented within the panels, and the text within the panels can provide sufficient context for an AI model (or combination of AI models) to generate a moving picture consistent with a narrative flow of the graphic narrative. Further, the combination of the relative locations of the panels, the image elements represented within the panels, and the text within the panels provide sufficient context clues for an AI model to determine fluid, continuous movements of the story within and between the stationary pictures represented in the panels of a print-version of the graphic narrative.

Further, as discussed more below, various AI models can be used to determine the areas and bounds of the panels. Other AI models can segment the images into image and text elements and then analyze these segments to ascertain/identify the objects depicted in the image elements and the referents/meaning of the text elements. Additional AI models can compare the identified objects and referents between respective panels (or within a one or more panels) to determine the narrative flow among the panels (or within the one or more panels).

According to certain non-limiting examples, the panels can be modified to be compatible with viewing in a digital format. For example, the font size of the text can be modified for visually impaired readers. Further, the size of the bubbles can be modified consistent with the change in the font size. This can entail using a generative AI tool to redraw part of the image elements. Additionally or alternatively, the text in the bubbles can be modified using a large language model (LLM), For example, to abbreviate the text without substantively changing its meaning. Thus, the modifications to text or dialog can be made to be consistent with the storyline, such that the modifications do not disrupt of flow of the storyline. Further, the font and style of the text can be adapted to be consistent with the style of graphic narrative. This can be achieved by using a generative artificial intelligence (AI) model to learn the style of the author/artist of the graphic narrative and then generating the modifications in the same style as the author/artist.

Additionally, the images within the graphic narrative can be modified as long as such modifications are consistent with the storyline and narrative flow. For example, the first panel 102a, third panel 102c, and fourth panel 102d each have irregular (non-rectangular) shapes. In each of these cases, the panels can be extended to a rectangular shape using a generative AI tool to draw additional background and foreground and thereby make these consistent with how they will be displayed in an e-reader, for example. That is, modified images can be achieved by using a generative AI model that learns the style of the author/artist of the graphic narrative, and generates modified images in the same style as the author/artist. Further, the modified images can be presented to the author/artist who then edits the modified images, if further editing is beneficial.

Additionally or alternatively, text and images can be modified in the background as well as in the foreground of the graphic narrative. Thus, modifications to graphic narrative can include modifying the formatting of panels to adapt them from a comic book format (or other graphic narrative format) to a format that is compatible with being displayed in an electronic reader (e-reader), a reader application, or a webpage. For example, on page 100, the size and shape of the panels are not uniform (e.g., some panels are not even rectangular). Further, on page 100, the trajectory of the reader's eye when following the narrative is not a straight line. The panels can be reformatted so that they can be more uniform in shape and so that they be scrolled either vertically or horizontally in an e-reader, for example. To make the panels more uniform in shape and size, a generative AI model can be used to fill in missing portions of the background and/or foreground.

FIG. 1B illustrates an example of labeling panels in a graphic narrative with information that can be used to produce prompts for a generative AI model to create moving pictures representing the story in the panels ant the narrative flow. Here, the first panel 102a has been labeled with panel 1 labels 112. This can include an index value that represents the position of this panel in an ordered list of the narrative flow. Further, the panel labels can include the identities of characters depicted in the given panel and the identities can be associated with the segmented images that are identified as the characters. Further, the panel labels can include classifications of background and foreground for respective segmented images. For portions of the panels identified as text elements, the panel labels can include information regarding the types of the bubbles (e.g., speech bubbles, thought bubbles, onomatopoeia, etc.) the source of the bubbles (e.g., the character speaking a given speech bubble), and a tone or emphasis of the text elements (e.g., an increased font size or all capital letters for an onomatopoeia or speech can convey increased sound volume).

The panel labels can be generated by an AI model based on segmented elements in the panels, and a reviewer can review the labels and make changes to them. For example, a semantic segmentation model and/or an object detection and segmentation can be used to segment panels and identify objects identified therein. Further, optical character recognition can be applied to text identified in the panels, and one or more language models can be used to determine referents and meanings of the text (e.g., what emotions are conveyed by a given character saying a given line of text). After the labels are generated by an AI model, the labels can be sent to a reviewer/editor who reviews the labels for their accuracy.

The AI model may occasionally be wrong or may not have sufficient information to confidently label the segmented elements of the panels. Thus, the reviewer/editor can review the automated results from the AI model and make changes where the AI model erred, providing significant time savings compared to labeling the panels by hand (e.g., it can be anticipated that a properly trained AI model is wrong for less the 5% or less than 1% of the labels). The review time can be reduced by flagging those panels or labels for which there is a high uncertainty (low confidence). Changes made by the authors/editors can be used for reinforcement learning by the AI model that is used to automate the generation of the labels.

The other panels in FIG. 1B are also labeled with panel labels. The second panel 102b is labeled with the panel 2 labels 114, and the third panel 102c is labeled with the panel 3 labels 116. The bubble showing onomatopoeia 110 is labeled with the panel 3 labels 116, and the fourth panel 102d is labeled with the panel 4 labels 118. The fifth panel 102e is labeled with the panel 6 labels 122.

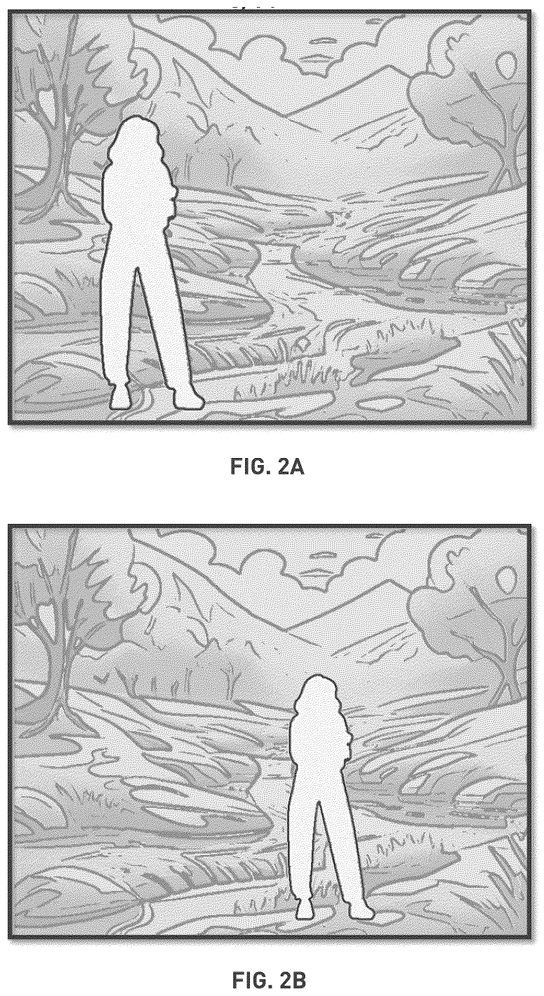

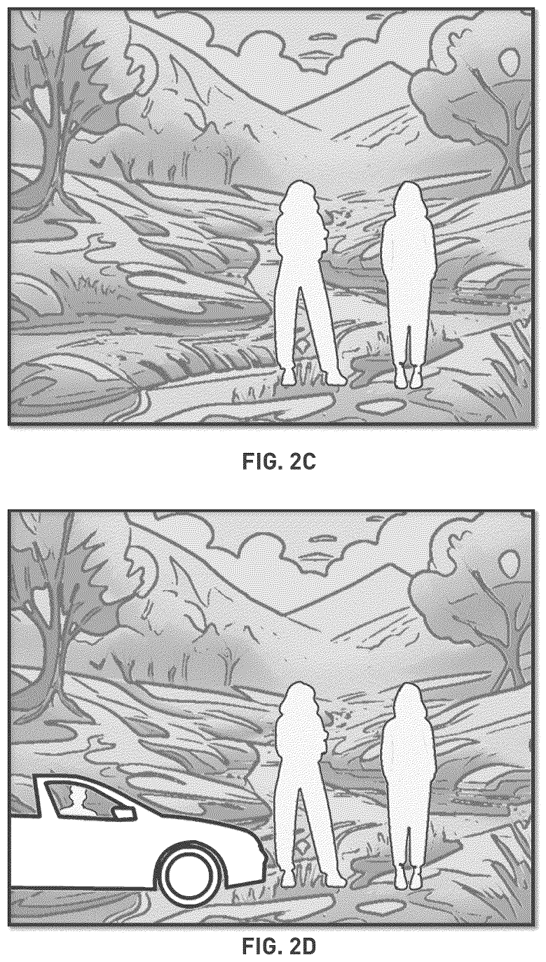

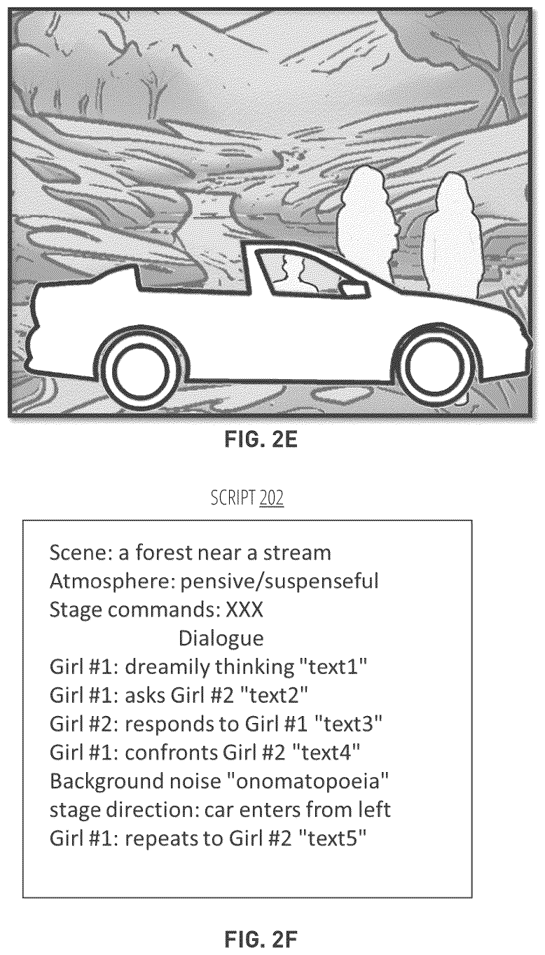

The labels of the panels are used to generate prompts, which are then applied as inputs to a moving-picture AI model to generate a moving picture. According to certain non-limiting examples, the prompts can include a script and one or more keyframes. For example, the keyframes can include a starting frame and a concluding frame. Further, the keyframes can include instructions regarding how the segmented elements within the keyframes move and/or change between the keyframes. FIG. 2A, FIG. 2B, FIG. 2C, FIG. 2D, and FIG. 2E illustrate examples of keyframes used to generate moving pictures between the respective panels.

For example, between a first frame in FIG. 2A and a second frame in FIG. 2B a character “Girl #1” moves from a first location with respect to the background to a second location with respect to the background, which corresponds to a transition from the first panel 102a to the second panel 102b.

The transition from the second frame in FIG. 2B to the third frame in FIG. 2C introduces another character “Girl #2” who first appears in the second panel 102b. In the second panel 102b and the third panel 102c the characters “Girl #1” and “Girl #2” carry out a conversation that includes “text2,” “text3,” and “text4”.

The fourth frame in FIG. 2D introduces a car that is driven in from the left of the screen. This car first appears in the fifth panel 102e, which occurs chronologically before the fourth panel 102d.

In the fifth frame in FIG. 2E, the car continues to move into the frame and concludes at the scene shown in the fourth panel 102d.

FIG. 2F illustrates a script corresponding to the narrative content of page 100. According to certain non-limiting examples, the prompts can include a script that provides a summary of the information in the labels. For example, the script can include the dialogue from the speech and thought bubbles. Further, the script can include the source of the dialogue, to whom the speech is directed, the tone of the speech, and other stage commands. Further, the script can include both global information, which can be derived from an entirety of the graphic narrative, and local information, which can be derived from the current panel(s). The global information can include an atmosphere, for example. Further, the global information can include information regarding the type of plot of the graphic narrative, the genre of the graphic narrative; and plot elements corresponding to respective parts of the graphic narrative. The local information can include, e.g., the scene and background where the moving picture occurs, the emotions to be evoked, the pacing of the moving picture, and atmospheric information. The script can include various stage commands.

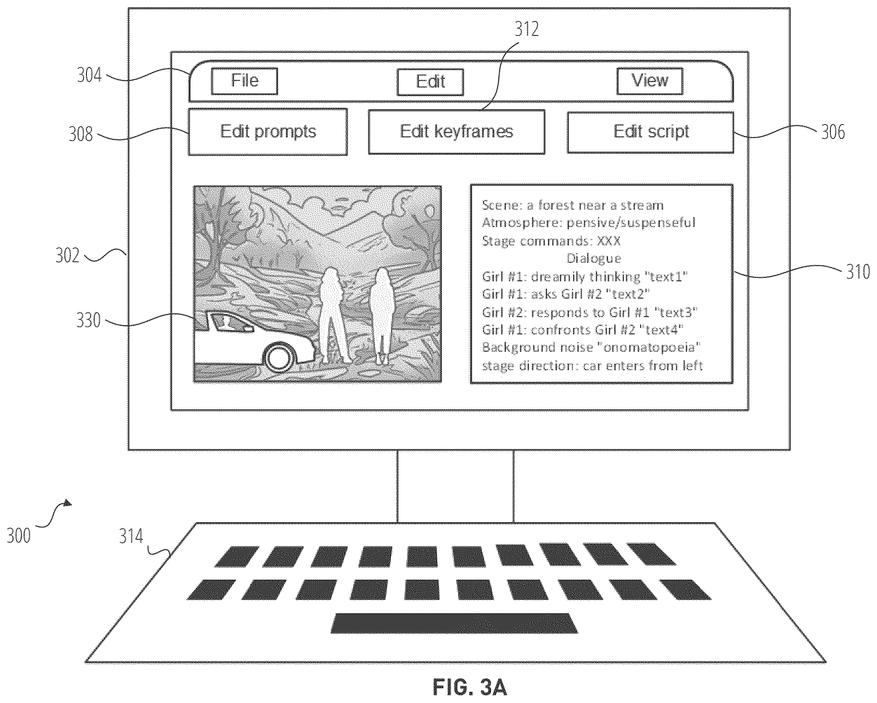

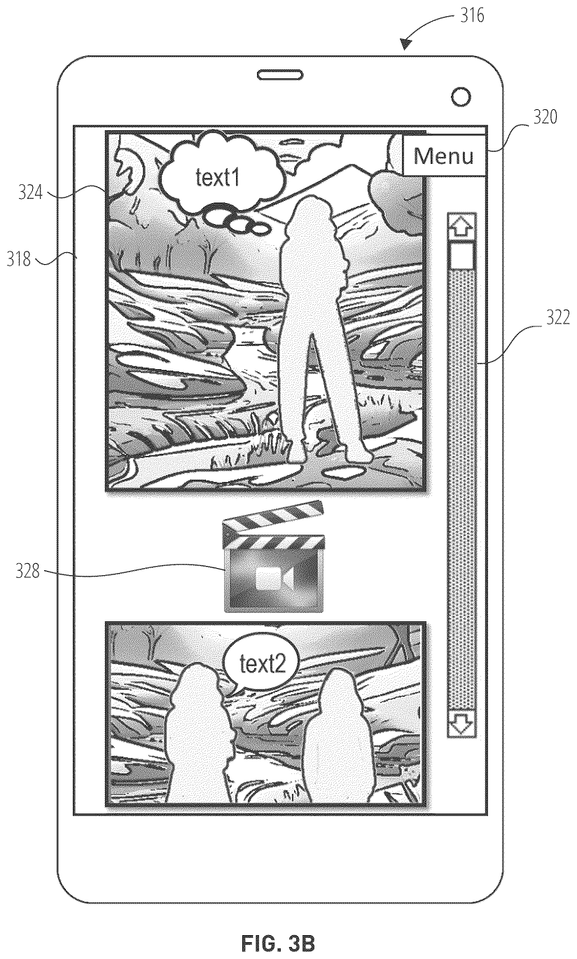

FIG. 3A illustrates a computing system 300 for modifying the labels and/or prompts used to generate moving pictures from print-based graphic narratives to display (e.g., on a screen of a user device) the moving pictures either within panels of a digital version of the graphic narrative or display the moving picture stitched together with other moving picture of other panels as a moving-picture film. The computing system 300 includes a display 302 (e.g., a computer monitor) and an input device 314 (e.g., a mouse and/or keyboard). According to certain non-limiting examples, the display 302 displays a menu ribbon 304, an edit script menu 306, an edit prompt menu 308, an edit keyframes menu 312, a script display window 310, and a keyframe display window 330.

The menu ribbon 304 can provide access to various dropdown menus, such as a file menu, an edit menu, and a view menu, which allow a reviewer various menu options for modifying a file (e.g., save, print, export, etc.), editing a file (e.g., track changes, etc.), and viewing the file (e.g., change font size, change window format, etc.). The edit script menu 306 can provide the reviewer with various editing options for editing the script in the script display window 310. The edit prompt menu 308 can pull up a window displaying various portions of the prompt to be modified by the reviewer. The edit keyframes menu 312 can provide the reviewer with various editing options for editing the frame shown in the keyframe display window 330.

FIG. 3B illustrates a mobile device 316 for displaying, within a display 318, a digital version of the graphic narrative that includes moving pictures. According to certain non-limiting examples, the mobile device 316 includes a menu 320 that allows a reader to change the display settings or customize the viewing experience using various drop-down menus and/or options menus. The mobile device 316 can include a scroll bar 322 or other tools to enter user inputs to manually control the path. According to certain non-limiting examples, the display 318 can include a moving-picture icon 328 that allows the user to access the moving picture corresponding to a panel by interacting with the moving-picture icon 328 (e.g., by clicking on the moving-picture icon 328). The moving-picture icon 328 can be superimposed over a portion of the corresponding panel or can be located proximately to the panel. Additionally or alternatively, the menu 320 can include a setting/option to automatically play the moving picture within the corresponding panel when the user scrolls to display the panel.

The mobile device 316 can be an e-reader that allows the reader to scroll through the panels vertically or horizontally. The mobile device 316 can be a user device such as a smartphone, a tablet, or a computer on which an application or software is installed that provides a multi-modal viewing experience by allowing the reader to view the panels arranged vertically, horizontally, or as a double paged spread. Additionally or alternatively, a reader can view the graphic narrative using web browser displayed on a monitor or display of a computer. The web browser can be used to access a website or content provider that displays the modified graphic narrative within the web browser or an application of the content provider.

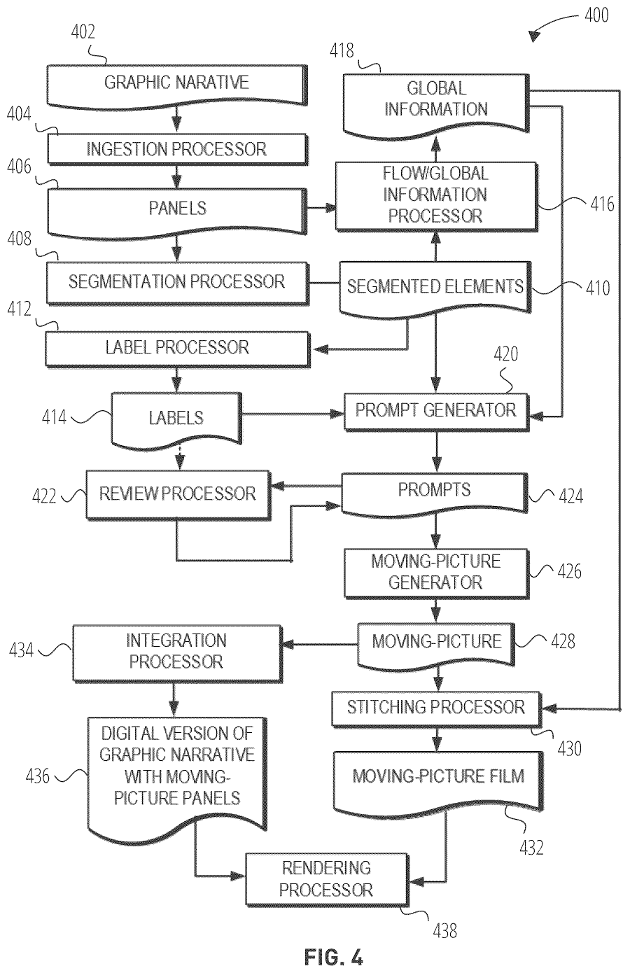

FIG. 4 illustrates a system 400 for generating moving pictures based on a print version of a graphic narrative, such as a comic book.

The graphic narrative 402 is received by an ingestion processor 404, which ingests a digital version of the graphic narrative 402. For example, the digital version can be generated by scanning physical pages of the graphic narrative. The digital version can be a Portable Document Format (PDF) file or another file extension type. The ingestion processor 404 identifies respective areas and boundaries for each of the panels. For example, the ingestion processor 404 can identify the edges of the panels and where the panels extend beyond nominal boundaries.

The segmentation processor 408 receives panels 406 and generates therefrom segmented elements 410, including image segments and text segments. The text segments can include text in various types of bubbles, as well as other text appearing in panels 406, such as onomatopoeia, text blocks, and narration.

The text can be in any of multiple different formats, including text in speech bubbles, thought bubbles, narrative boxes, exposition, onomatopoeia (e.g., “wow,” “pow,” and “zip”), text appearing in the background (e.g., on signs or on objects). Further, the text can be in various sizes and fonts or can even be hand-lettered text.

The panels can be segmented using various models and techniques, such as semantic segmentation models, which include Fully Convolutional Network (FCN) models, U-Net models, SegNet models, a Pyramid Scene Parsing Network (PSPNet) models, and DeepLab models. The segmentation processor 408 can also segment panels 406 using image segmentation models, such as Mask R-CNN, GrabCut, and OpenCV. The segmentation processor 408 can also segment panels 406 using Object Detection and Image Segmentation models, such as fast R-CNN models, faster R-CNN models, You Only Look Once (YOLO) models, PASCAL VOC models, COCO models, and ILSVRC models. The segmentation processor 408 can also segment panels 406 using Single Shot Detection (SSD) models, such as Single Shot MultiBox Detector models. The segmentation processor 408 can also segment panels 406 using detection transformer (DETR) models such as Vision Transformer (ViT) models.

Many of the above models identify the objects within the segmented elements, but, for other segmentation models, a separate step is used to identify the object depicted in the segmented elements. This identification step can be performed using a classifier model or a prediction model. For example, identifying labels 414 can be performed using an image classifier, such as K-means models or Iterative Self-Organizing Data Analysis Technique (ISODATA) models. The following models can also be trained to provide object identification capabilities for segmented images: YOLO models, ResNet models, ViT models, a Contrastive Language-Image Pre-Training (CLIP) models, convolutional neural network (CNN) models, MobileNet models, and EfficientNet models.

For segmented elements 410, a two-step process can be used in which optical character recognition is used, e.g., to map a segment with text to an order set of alphanumeric characters (e.g., an ASCII character string of the text), and then a language model is applied to determine the referent or the type referent that is referred to by the text. For example, a natural language processing (NLP) model or large language model (LLM) can be used such as a transformer model, a Generative pre-trained transformers (GPT) model, a Bidirectional Encoder Representations from Transformers (BERT) model, or a T5 model.

The flow and global information processor 416 determines global information 418, which can include an order in which the storyline flows from one panel to another (and flows within one or more panels). According to certain non-limiting examples, the flow and global information processor 416 refers to the locations of the individual panels on a page and predicts their intended reading order based on comic book conventions (e.g., left-to-right, top-to-bottom for English-language comics), artistic cues, and textual cues. Further, the flow and global information processor 416 can analyze visual elements (e.g., characters, objects, locations, action sequences) and textual elements (e.g., dialogue, captions, sound effects) to understand the content of the panel. The flow and global information processor 416 can use the results of the content analysis to create a dynamic path of action through the respective panel and among panels. This path can include elements such as zoom, pan, and transitions.

Further, the flow and global information processor 416 can generate additional values as part of the global information 418, and these additional values can include a type of the plot, a genre of the graphic narrative, a setting of the graphic narrative, an atmosphere of the graphic narrative. For example, the type of the plot can be an overcoming-the-monster plot; a rags-to-riches plot; a quest plot; a voyage-and-return plot; a comedy plot; a tragedy plot; or a rebirth plot. Additionally, the plot elements can include exposition, conflict, rising action, falling action, and resolution elements. The genre can be an action genre; an adventure genre; a comedy genre; a crime and mystery genre; a procedural genre, a death game genre; a drama genre; a fantasy genre; a historical genre; a horror genre; a mystery genre; a romance genre; a satire genre, a science fiction genre; a superhero genre; a cyberpunk genre; a speculative genre; a thriller genre; or a western genre. The settings can be, e.g., an urban setting, a rural setting, a nature setting, a haunted setting, a war setting, an outer-space setting, a fantasy setting, a hospital setting, an educational setting, a festival setting, a historical setting, a forest, a dessert, a beach, a water setting, a travel setting, or an amusement-park setting. The atmospheres can be, e.g., a reflective atmosphere; a gloomy atmosphere; a humorous atmosphere; a melancholy atmosphere; an idyllic atmosphere; a whimsical atmosphere; a romantic atmosphere; a mysterious atmosphere; an ominous atmosphere; a calm atmosphere; a lighthearted atmosphere; a hopeful atmosphere; an angry atmosphere; a fearful atmosphere; a tense atmosphere; or a lonely atmosphere.

Additionally, the global information 418 can include information relevant to the graphic narrative that is derived from other graphic narratives in the same series, from databases, fandom websites, or wikis that are related to the graphic narrative. For example, a significant amount of information about a superhero character, their backstory, their personality, and their appearance may be available on a wiki or proprietary database that is maintained to preserve information about the superhero character. Information summarizing the character's temperament and personality can be encoded in the global information 418 either as structured or unstructured data. According to certain non-limiting examples, a 3D model of the character's appearance and movement attributes can be generated from images in the graphic narrative and other images available in a fan website, wiki, or proprietary database. This 3D model can be encoded in the global data. According to certain non-limiting examples, a voice mode can also be generated for the character based on archived data available in a fan website, wiki, or proprietary database, for example.

The label processor 412 generates labels 414 based on the segmented elements 410, According to certain non-limiting examples, the labels 414 are also generated based on the global information 418.

According to certain non-limiting examples, the label processor 412 can use a large language model (LLM), such as those discussed above for the segmentation processor 408, to summarize the information in the segmented elements 410 and the global information 418.

The prompt generator 420 generates prompts 424 based at least partly on the labels 414. The prompt generator 420 can include one or more AI models that analyze the labels, the image segments, and the text segments to synthesize therefrom the prompts 424. The prompts 424 are used as instructions used by the moving-picture generator 426 to generate the moving picture 428. These instructions capture the semantic and communicative content of the panels in a format that can be used to generate the moving picture 428 such that it is consistent with the corresponding panels of the graphic narrative.

For example, a comic book version of a graphic narrative can effectively serve as a storyboard for generating a moving picture of the graphic narrative. The prompts 424 can include this storyboard, which can be augmented with additional information to interpolate/extrapolate and fill any gaps remaining in the storyboard.

According to certain non-limiting examples, prompts 424 can represent script information, storyboard information, or scene information corresponding to one or more of the panels. For example, the prompts can include keyframes and scripts, as illustrated in FIG. 2A-FIG. 2E, and FIG. 2F. An example of a script 202 is shown in FIG. 2F. Examples of keyframes for page 100 are shown in FIG. 2A, FIG. 2B, FIG. 2C, FIG. 2D, and FIG. 2E.

According to certain non-limiting examples, as illustrated in FIG. 2F, the script information included in the prompts can include dialogue between characters, the source of the dialogue, to whom the dialogue is directed, the tone of the dialogue, and various stage commands. Further, the script can include both global information, which can be derived from an entirety of the graphic narrative, and local information, which can be derived from the current panel(s). The global information can include an atmosphere, for example. Further, the global information can include information regarding the type of plot of the graphic narrative, the genre of the graphic narrative; and plot elements corresponding to respective parts of the graphic narrative. The local information can include, e.g., the scene and background where the moving picture occurs, the emotions to be evoked, the pacing of the moving picture, and atmospheric information. The script can include various stage commands.

The keyframes can be information, drawings, or images that define the starting and ending points of a smooth transition in a moving picture. Prompts 424 can also include keyframing instructions including, e.g., (i) instructions directing the generation of keyframes at intervals throughout the moving picture, wherein the keyframes include at least positions of the image segments in a starting frame and position of the image segments in a concluding frame; (ii) an instruction regarding how one or more of the foreground elements move between the keyframes; or (iii) instructions regarding how the one or more of the background elements move between the keyframes. For example, a grass field identified in a background element can be accompanied with an instruction to make the grass field appear to be rippling or swaying in a breeze. Further, a character in the foreground may be accompanied with instructions that they are leaping in a parabolic arc or that they are gliding in the wind.

According to certain non-limiting examples, the script can include one or more stage commands including, e.g., (i) an instruction directing the pace of the moving picture; (ii) a script of dialogue between one or more characters of the moving picture; (iii) an instruction regarding emotions emoted by the one or more characters; (iv) an instruction regarding a tome/mood conveyed by the moving picture; or (v) an instruction regarding one or more plot devices to apply in the moving picture.

The labels 414 and the prompts 424 can include image information and text information, which are respectively derived from the image segments and the text segments from the panels. The image information can include, e.g., indicia of which of the image segments are foreground elements and background elements, indicia for how respective image segments move, and/or indicia of textures and/or light reflection physics from the image segments. The text information can include, e.g., indicia of which of the text segments are dialogue, character thoughts, sounds, or narration, and/or indicia of a source/origin of the text segments. According to certain non-limiting examples, prompts 424 can include keyframing instructions and stage commands based on the image information and the text information.

According to certain non-limiting examples, labels 414 and/or prompts 424 can include labels/information indicating which of the text segments include onomatopoeia, narration, or dialogue. Further, labels 414 and/or prompts 424 can include text labels/information indicating, for respective dialogue segments, the respective sources of the dialogue segments and a tone, volume, or emotion of the dialogue segment. Additionally, labels 414 and/or prompts 424 can include labels/information indicating, for respective characters that are identified in the image segments, the character's name and other attributes.

According to certain non-limiting examples, prompts 424 can include an instruction to render the moving picture as either a live-action moving picture or as an animated moving picture of a specified animation style.

As discussed above, the prompt generator 420 can use one or more AI models that analyze the labels 414, the segmented elements 410, and/or the global information 418, and, based on that analysis, the prompt generator 420 produces/synthesizes the prompts 424. For example, one or more parts of the prompts 424 (e.g., the script) can be produced by a generative AI model for generating text, such as a transformer neural network (e.g., a GPT model or a BERT model). Additionally, one or more parts of the prompts 424 (e.g., the keyframes) can be produced by a generative AI model for generating images, such as a generative adversarial network (GAN) model, a Variational autoencoder (VAE) model, a Deep Dream model, Neural Style Transfer model, and/or a Stable Diffusion Generator model.

Optionally, the prompt generator 420 generates the prompts 424 based on the labels 414 based on the global information 418, in addition to the labels 414.

The review processor 422 enables a reviewer to review the prompts 424 and make changes to the prompts 424. For example, the prompts 424 can be sent together with other contextual information (e.g., the labels 414 and/or images of the pages of the graphic narrative) to a review processor 422 in the computing system 300, and the reviewer can use the computing system 300 to review the prompts 424 for accuracy. For example, the reviewer can correct where an AI model mislabeled one of the characters. Further, the graphic narrative may be ambiguous with respect to certain details, such as which direction a character enters a scene from. Thus, a reviewer can resolve such ambiguities and/or add additional instructions or comments to the prompts. For example, a reviewer may clarify that the moving pictures are to be created in a particular artistic/artist's style that is different from the original graphic narrative.

The moving-picture generator 426 generates one or more moving pictures 428 based on the prompts 424. The moving-picture generator 426 can include one or more AI models that generate the moving pictures 428 based on the prompts 424. For example, the moving-picture generator 426 can include a generative adversarial network (GAN) model; a Stable Diffusion model; a DALL-E Model; a Craiyon model; a Deep AI model; a Runaway AI model; a Colossyan AI model; a DeepBrain AI model; a Synthesia.io model; a Flexiclip model; a Pictory model; a In Video.io model; a Lumen5 model; and a Designs.ai Videomaker model.

The moving-picture generator 426 can be a generative AI model that is trained, for example, using either supervised or unsupervised learning. For supervised learning, the generative AI model can be trained using a corpus of training data that includes inputs associated with respective outputs to the generative AI model. As inputs, the training data can include prompts generated from the corresponding moving pictures. Additionally or alternatively, as inputs, the training data can include storyboards and prompts generated from the storyboards, and the films generated based on these storyboards can be used as the outputs and corresponding to the storyboards and prompts generated therefrom. Further, a corpus of comic books, manga, and manhwa can be associated with corresponding moving pictures from TV episodes and movies. For example, the manga series ONE PIECE has been used as the basis for over 1000 TV episodes.

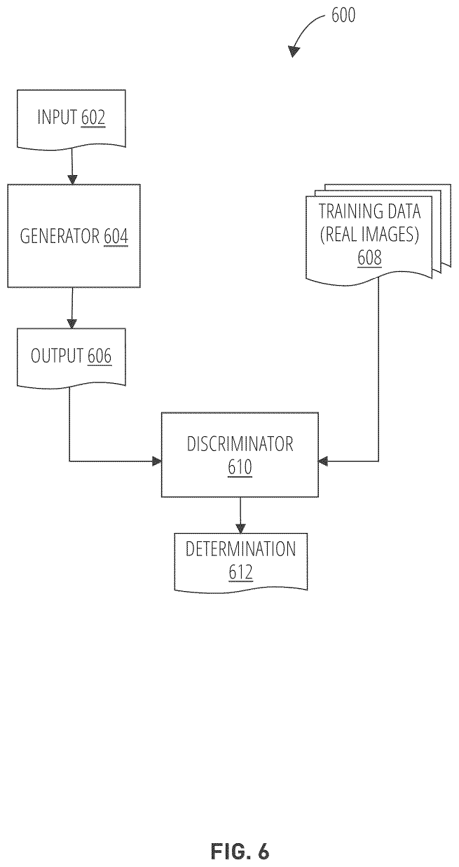

For unsupervised learning, a generative AI model can be trained for a GAN model that compares moving pictures generated by the generative AI model to a corpus of actual moving pictures. Training of GAN models are further discussed below, with reference to FIG. 6.

The integration processor 434 integrates the one or more moving pictures 428 into a digital graphic narrative 436. As shown in FIG. 3B, the moving picture can be rendered within a panel of the digital version of the graphic narrative. For example, the digital version the graphic narrative can show a still illustration of the panel, and then when the user interacts with the panel in a prescribed manner (e.g., by clicking on the panel or on a portion of the panel, such as where a moving-picture icon 328 is located), the moving picture will play in the panel. According to certain non-limiting examples, when the moving picture finishes playing, the panel can display the last frame of the moving picture or can return to the still illustration of the panel. Additionally or alternatively, the moving picture can continue to play on a loop, until a user action signals the moving picture to stop playing.

Additionally or alternatively, the moving picture can play in a region near the panel rather than directly within the panel of the digital version the graphic narrative.

As an alternative to integrating the moving pictures 428 into a digital version of the graphic narrative, a moving-picture film 432 can be generated by stitching together the respective moving pictures. For example, the moving-picture film 432 can be a feature film or TV episode that conveys the entire story line of the graphic narrative. A stitching processor 430 can be used to stitch together and/or concatenate the one or more moving pictures 428 into a moving-picture film 432.

For example, the global information 418 can be used to ensure coherence and consistency among the moving pictures 428 generated from neighboring panels. Then, many shorter-duration moving pictures can be combined into a single moving picture that has a duration that is substantially the sum of the lengths of the shorter-duration moving pictures. The order in which the many shorter-duration moving pictures are concatenated is determined by the narrative flow determined by the flow and global information processor 416. For example, the narrative flow can be singled by index values assigned to the respective panels, wherein the narrative flow is an order in which the panels are to be viewed and the index values represent positions in an ordered list that corresponds to the narrative flow. The stitching processor 430 can use a generative AI model to provide transitions between the respective moving pictures.

According to certain non-limiting examples, the stitching processor 430 can generate a title sequence of the graphic narrative. For example, the title sequence is a part of moving-picture film 432 that lists contributors to the graphic narrative and lists their contributions. The title sequence can be automatically generated based on parsing text segments in the front matter of the graphic narrative. For example, the title sequence can be automatically generated based on parsing text segments on a title page and/or on the printing page of the graphic narrative. Then from these parsed text segments, an LLM can be used to determine who are the contributors and what are the contributions ascribed to the respective contributors.

The rendering processor 438 renders the resulting product (e.g., the digital graphic narrative 436 or the moving-picture film 432) so that it can be displayed on a display device.

According to certain non-limiting examples, the 438 can determine how to render the resulting product for a particular device and in a particular user interface (UI) or user experience (UX) that is being used for viewing of that version of the graphic narrative (i.e., the digital graphic narrative 436 or the moving-picture film 432)

The system 400 can be distributed across multiple computing platforms and devices. For example, units 404, 408, 412, 416, 420, 426, 430, 434, and 438 can be located on a computing system 300 of the author/editor or in a cloud computing environment. Additionally, units 404, 408, 412, 416, 420, 430 and 434 can be located on a computing system 300 of the publisher or in a cloud computing environment, and unit 422 can be located on a computing system 300 of the reviewer. Further, unit 438 can be located on a reader's mobile device 316 or in a cloud computing environment.

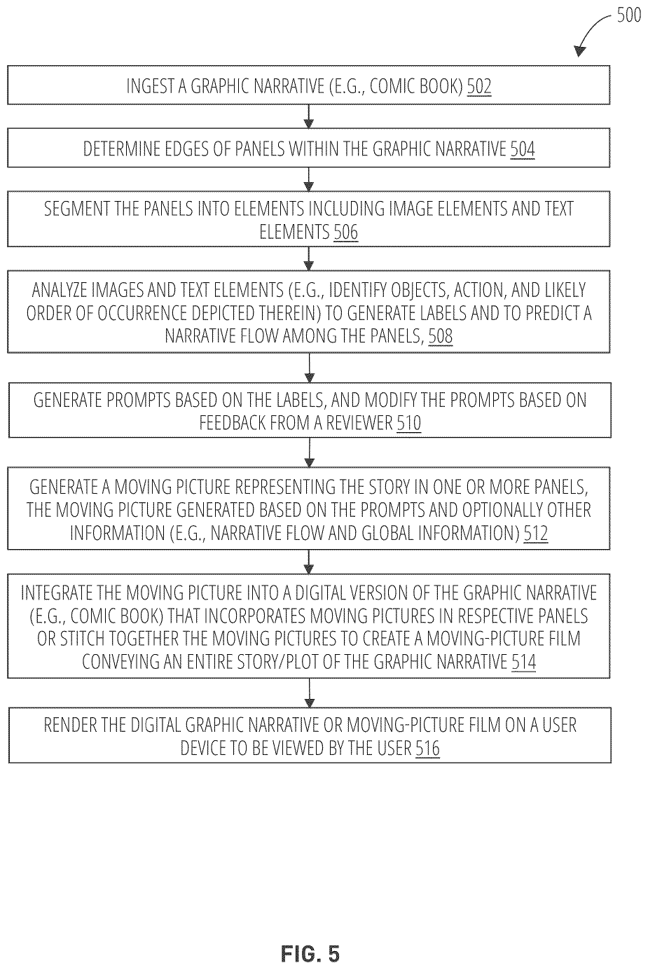

FIG. 5 illustrates an example method 500 for converting a graphic narrative (e.g., a comic book) to moving pictures and either integrating the motion pictures into a digital version the graphic narrative or stitching the moving pictures together as a moving-picture film. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

According to certain non-limiting examples, step 502 of the method includes ingesting a graphic narrative. Step 502 can be performed by the ingestion processor 404 in FIG. 4, for example.

According to certain non-limiting examples, step 504 of the method includes determining the edges of panels within the graphic narrative. Step 504 can be performed by the ingestion processor 404 in FIG. 4, for example.

According to certain non-limiting examples, step 506 of the method includes segmenting the panels into elements including image elements and text elements. Step 506 can be performed by the segmentation processor 408 in FIG. 4, for example. The segmentation can be performed, e.g., using semantic segmentation models (e.g., FCN, U-Net, SegNet, PSPNet, DeepLab, etc) that perform semantic segmentation using an Encoder-Decoder structure or Multi-Scale representation structure, thereby generating distinct segments that correspond to respective elements within each of the panels. Other segmentation models, which are discussed with reference to FIG. 4, can also be used to perform step 506.

The segmented elements can include background, foreground, text bubbles, text blocks, and onomatopoeia, and the background and foreground can be further sub-divided into individual characters, objects, and buildings.

According to some examples, step 508 of method 500 includes analyzing segmented elements 410 to generate labels and to predict a narrative flow among the panels, These task of generating labels and predicting the narrative flow can be performed using the label processor 412 and 416, respectively, and they can be performed using any of the techniques or models described with reference thereto. For example, step 508 can include segmenting the panels to identify images and text elements (e.g., identify objects, action, and likely order of occurrence depicted therein). Further, step 508 can include predicting a narrative flow among the panels. For example,

According to certain non-limiting examples, step 508 can include predicting the narrative flow among the panels, and flagging instances where the prediction is unclear, step 508 can include identifying objects depicted in the image elements and referents referred to in the text elements.

According to certain non-limiting examples, step 510 can include applying the segmented elements 410 to a machine learning (ML) model to predict a narrative flow, the predicted narrative flow comprising an order in which the panels are to be viewed, step 510 can further include assigning, in accordance with the predicted narrative flow, index values to the respective panels, the index values representing positions in an ordered list that corresponds to the predicted narrative flow.

According to certain non-limiting examples, applying the segmented elements to the first ML model to predict the narrative flow can include: analyzing relations among the text elements the same page to determine first scores representing likelihoods for an order in which the text elements are viewed, analyzing the relations among the text elements a same page to determine second scores representing likelihoods for an order in which the image elements are viewed, and combining the first scores and the second scored to predict order in which the panels are to be viewed.

According to certain non-limiting examples, step 510 includes generating a moving picture representing the story in one or more panels. This can be performed using the moving-picture generator 426 shown in FIG. 4 and can be performed using any of the techniques or models described with reference thereto. The moving picture can be generated based on the prompts and optionally other information (e.g., narrative flow and global information). Moving pictures can be generated for all or some of the panels in the graphic narrative.

According to certain non-limiting examples, step 512 includes integrating the moving picture into a digital version of the graphic narrative (e.g., comic book) that incorporates moving pictures in respective panels of a digital version of the graphic narrative. This can be performed using the integration processor 434 shown in FIG. 4 and can be performed using any of the techniques or models described with reference thereto. Additionally or alternatively, step 512 includes stitching together the moving pictures to create a moving-picture film conveying an entire story/plot of the graphic narrative. This can be performed using the stitching processor 430 shown in FIG. 4 and can be performed using any of the techniques or models described with reference thereto.

According to certain non-limiting examples, step 514 of the method includes determining transitions focus elements guiding user experience between story elements and panels according to narrative flow, and finalizing narrative flow. Step 514 can further include modifying some of the elements to be compatible with being displayed in an e-reader. Step 514 can be performed by the flow and global information processor 416 and the prompt generator 420 in FIG. 4, and use one or more of the generative AI models disclosed in reference to FIG. 4. Step 514 can include modifying the selected elements within the selected panels such that the modified elements promote the selected products. For image elements, a GAN model can be used to generate a modified image element that is directed to promoting or featuring a selected product. For text elements, an LLM can be used to transform the original text to modified text that refers to the selected product, and a GAN can be used to render that text in the style/font of the original text element.

According to some examples, at step 516, the method includes rendering the digital version of the graphic narrative with the integrated moving pictures or rendering the moving-picture film such that it can be displayed on a user device. For example, step 516 can include displaying a digital version of the graphic narrative on an electronic reader, an application, or within a web browser. Further, step 516 can include displaying a moving-picture film on an electronic reader, an application, or within a web browser. Step 516 can be performed by the rendering processor 438 in FIG. 4 or by a mobile device 316 prompt generator 420 in FIG. 3B, for example.

FIG. 6 illustrates a GAN architecture 600. The GAN architecture 600 has two parts: the generator 604 and the discriminator 610. The generator 604 learns to generate plausible moving pictures. The discriminator 610 learns to distinguish the plausible images of the generator 604 from real moving pictures from a corpus of training data. The discriminator 610 receives two moving pictures (i.e., the output 606 from the generator 604 and a real moving picture from the training data 608), and analyzes the two moving pictures to make a determination 612 which is the real moving picture. The generator 604 fools the discriminator 610 when the determination 612 is incorrect regarding which of the moving pictures received by the discriminator 610 was real.

Both the generator and the discriminator are neural networks with weights between nodes in respective layers, and these weights are optimized by training against the training data 608, e.g., using backpropagation. The instances when the generator 604 successfully fools the discriminator 610 become negative training examples for the discriminator 610, and the weights of the discriminator 610 are updated using backpropagation. Similarly, the instances when the generator 604 is unsuccessfully in fooling the discriminator 610 become negative training examples for the generator 604, and the weights of the generator 604 are updated using backpropagation.

When the GAN architecture 600 is used to train the moving-picture generator 426 (i.e., the generator 604), a prompt summarizing the content of the real moving picture is applied as an input to the generator 604, which generates a moving picture as the output 606. The prompts corresponding to the real moving pictures in the corpus of training data can be human generated or can be generated by another ML model (e.g., a dictation model to turn the spoken content of the real moving pictures into a script). Further, periodic frames in the real moving pictures can be captured and used as keyframes.

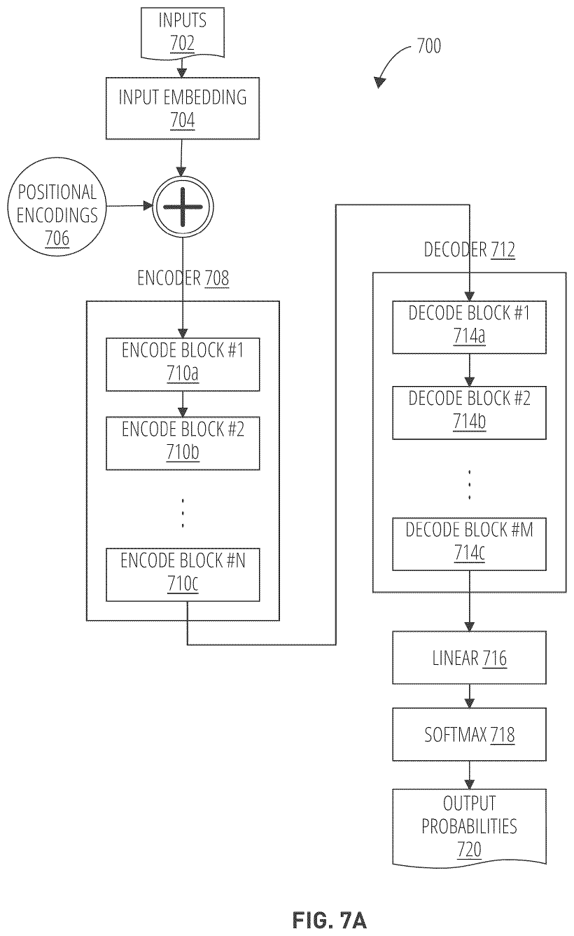

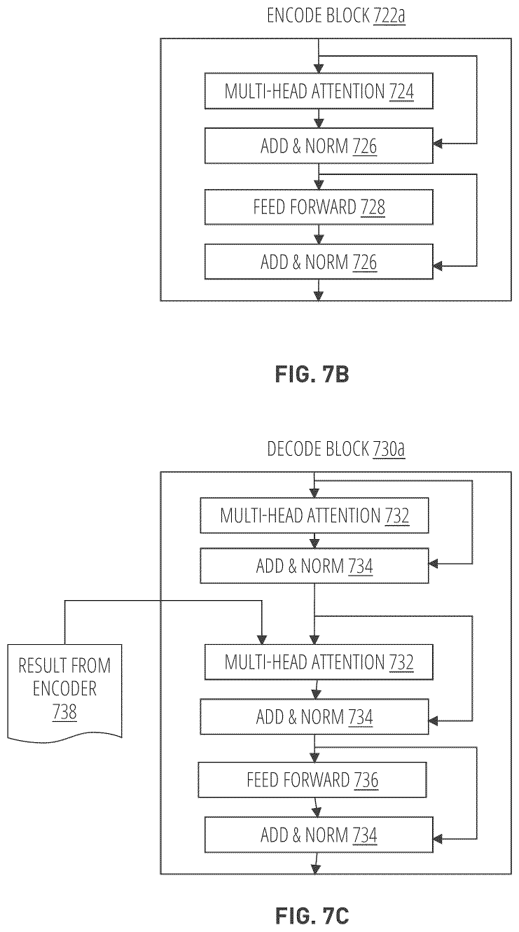

A transformer architecture 700 could be used to interpret and generate text for the labels and/or prompts. Examples of transformers include a Bidirectional Encoder Representations from Transformer (BERT) and a Generative Pre-trained Transformer (GPT). The transformer architecture 700, which is illustrated in FIG. 7A through FIG. 7C, includes inputs 702, an input embedding block 704, positional encodings 706, an encoder 708 (e.g., encode blocks 710a, 710b, and 710c), a decoder 712 (e.g., decode blocks 514a, 514b, and 714c), a linear block 716, a softmax block 718, and output probabilities 720.

The inputs 702 can include log files. The transformer architecture 700 is used to determine output probabilities 720 regarding regular expressions,

The input embedding block 704 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 704 can be learned embeddings to convert the input tokens and output tokens to vectors of dimension have the same dimension as the positional encodings, for example.

The positional encodings 706 provide information about the relative or absolute position of the tokens in the sequence. According to certain non-limiting examples, the positional encodings 706 can be provided by adding positional encodings to the input embeddings at the inputs to the encoder 708 and decoder 712. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that so doing allows the model to extrapolate to sequence lengths longer than the ones encountered during training.

The encoder 708 uses stacked self-attention and point-wise, fully connected layers. The encoder 708 can be a stack of N identical layers (e.g., N=6), and each layer is an encode block 410, as illustrated by encode block 710a shown in FIG. 7B. Each encode block 410 has two sub-layers: (i) a first sub-layer has a multi-head attention encode block 722a and (ii) a second sub-layer has a feed forward add & norm block 726, which can be a position-wise fully connected feed-forward network. The feed forward add & norm block 726 can use a rectified linear unit (ReLU).

The encoder 708 uses a residual connection around each of the two sub-layers, followed by an add & norm multi-head attention block 724, which performs normalization (e.g., the output of each sub-layer is LayerNorm (x+Sublayer (x)), i.e., the product of a layer normalization “LayerNorm” time the sum of the input “x” and output “Sublayer (x)” pf the sublayer LayerNorm (x+Sublayer (x)), where Sublayer (x) is the function implemented by the sub-layer). To facilitate these residual connections, all sub-layers in the model, as well as the embedding layers, produce output data having a same dimension.

Similar to the encoder 708, the decoder 712 uses stacked self-attention and point-wise, fully connected layers. The decoder 712 can also be a stack of M identical layers (e.g., M=6), and each layer is a decode block 414, as illustrated by encode decode block 714a shown in FIG. 7C. In addition to the two sub-layers (i.e., the sublayer with the multi-head attention encode block 722a and the sub-layer with the feed forward add & norm block 726) found in the encode block 710a, the decode block 714a can include a third sub-layer, which performs multi-head attention over the output of the encoder stack. Similar to the encoder 708, the decoder 712 uses residual connections around each of the sub-layers, followed by layer normalization. Additionally, the sub-layer with the multi-head attention encode block 722a can be modified in the decoder stack to prevent positions from attending to subsequent positions. This masking, combined with fact that the output embeddings are offset by one position, ensures that the predictions for position i can depend only on the known output data at positions less than i.

The linear block 716 can be a learned linear transfor-mation. For example, when the transformer architecture 700 is being used to translate from a first language into a second language, the linear block 716 projects the output from the last decode block 714c into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

The softmax block 718 then turns the scores from the linear block 716 into output probabilities 720 (which add up to 1.0). In each position, the index provides for the word with the highest probability, and then map that index to the corresponding word in the vocabulary. Those words then form the output sequence of the transformer architecture 700. The softmax operation is applied to the output from the linear block 716 to convert the raw numbers into the output probabilities 720 (e.g., token probabilities).

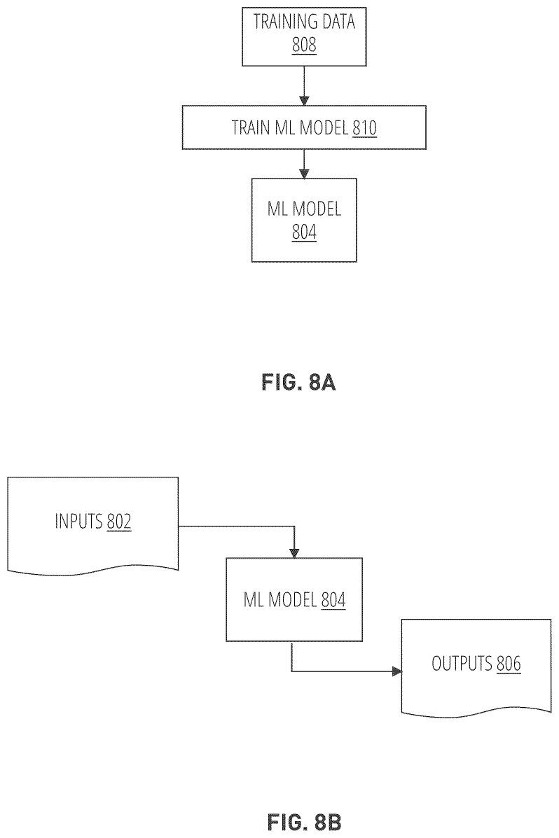

FIG. 8A illustrates an example of training an ML model 804. In step 810, training data inputs 802 is applied to train the ML model 804. For example, the ML model 804 can be an artificial neural network (ANN) that is trained via unsupervised or self-supervised learning using a backpropagation technique to train the weighting parameters between nodes within respective layers of the ANN.

An advantage of the GAN architecture 600 and the transformer architecture 700 is that they can be trained through self-supervised learning or unsupervised models. The Bidirectional Encoder Representations from Transformer (BERT), For example, does much of its training by taking large corpora of unlabeled text, masking parts of it, and trying to predict the missing parts. It then tunes its parameters based on how much its predictions were close to or far from the actual data. By continuously going through this process, the transformer architecture 700 captures the statistical relations between different words in different contexts. After this pretraining phase, the transformer architecture 700 can be finetuned for a downstream task such as question answering, text summarization, or sentiment analysis by training it on a small number of labeled examples.

In unsupervised learning, the training data 808 is applied as an input to the ML model 804, and an error/loss function is generated by comparing the predictions of the next word in a text from the ML model 804 with the actual word in the text. The coefficients of the ML model 804 can be iteratively updated to reduce an error/loss function. The value of the error/loss function decreases as outputs from the ML model 804 increasingly approximate the training data 808.

For example, in certain implementations, the cost function can use the mean-squared error to minimize the average squared error. In the case of a multilayer perceptrons (MLP) neural network, the backpropagation algorithm can be used for training the network by minimizing the mean-squared-error-based cost function using a gradient descent model.

Training a neural network model essentially means selecting one model from the set of allowed models (or, in a Bayesian framework, determining a distribution over the set of allowed models) that minimizes the cost criterion (i.e., the error value calculated using the error/loss function). Generally, the ANN can be trained using any of numerous algorithms for training neural network models (e.g., by applying optimization theory and statistical estimation).

For example, the optimization model used in training artificial neural networks can use some form of gradient descent, using backpropagation to compute the actual gradients. This is done by taking the derivative of the cost function with respect to the network parameters and then changing those parameters in a gradient-related direction. The backpropagation training algorithm can be: a steepest descent model (e.g., with variable learning rate, with variable learning rate and momentum, and resilient backpropagation), a quasi-Newton model (e.g., Broyden-Fletcher-Goldfarb-Shannon, one step secant, and Levenberg-Marquardt), or a conjugate gradient model (e.g., Fletcher-Reeves update, Polak-Ribiére update, Powell-Beale restart, and scaled conjugate gradient). Additionally, evolutionary models, such as gene expression programming, simulated annealing, expectation-maximization, non-parametric models and particle swarm optimization, can also be used for training the ML model 804.

The training 810 of the ML model 804 can also include various techniques to prevent overfitting to the training data 808 and for validating the trained ML model 804. For example, bootstrapping and random sampling of the training data 808 can be used during training.

In addition to supervised learning used to initially train the ML model 804, the ML model 804 can be continuously trained while being used by using reinforcement learning.

Further, other machine learning (ML) algorithms can be used for the ML model 804, and the ML model 804 is not limited to being an ANN. For example, there are many machine-learning models, and the ML model 804 can be based on machine learning systems that include generative adversarial networks (GANs) that are trained, For example, using pairs of network measurements and their corresponding optimized configurations.

As understood by those of skill in the art, machine-learning based classification techniques can vary depending on the desired implementation. For example, machine-learning classification schemes can utilize one or more of the following, alone or in combination: hidden Markov models, recurrent neural networks (RNNs), convolutional neural networks (CNNs); Deep Learning networks, Bayesian symbolic models, general adversarial networks (GANs), support vector machines, image registration models, and/or applicable rule-based systems. Where regression algorithms are used, they can include but are not limited to: a Stochastic Gradient Descent Regressors, and/or Passive Aggressive Regressors, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

FIG. 8B illustrates an example of using the trained ML model 804. The inputs 802 and/or instructions for modifying the inputs 802 are applied as inputs to the trained ML model 804 to generate the outputs, which can include the outputs 806.

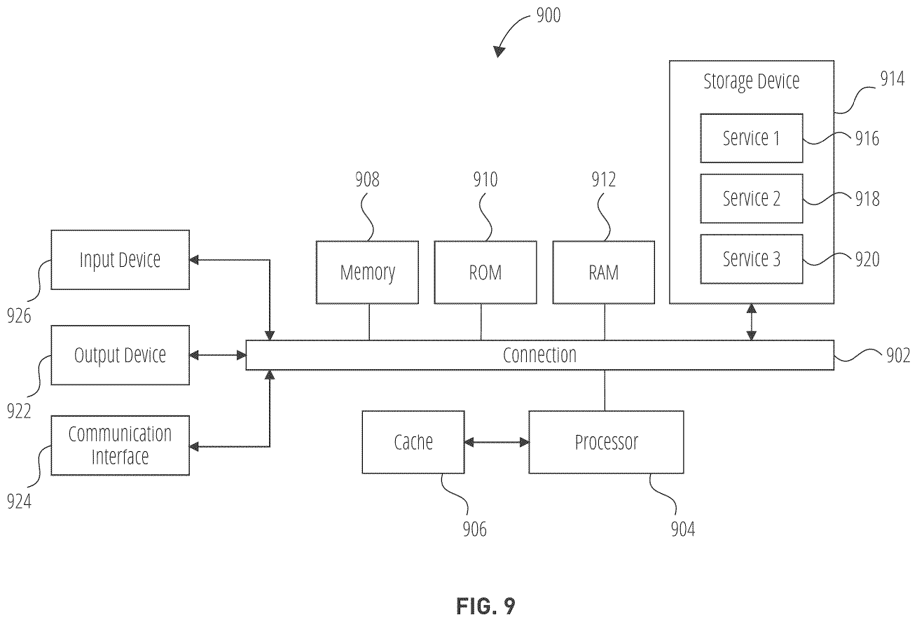

FIG. 9 shows an example of computing system 900. The computing system 900 can be the computing system 300 or the mobile device 316. The computing system 900 can perform the functions of one or more of the units in the system 400 and can be used to perform one or more of the steps of method 500. The computing system 900 can be part of a distributed computing network in which several computers perform respective steps in method 500 and/or the functions of units in system 400. The computing system 900 can be connected to the other parts of the distributed computing network via the connection 902 or the communication interface 924. Connection 902 can be a physical connection via a bus, or a direct connection into processor 904, such as in a chipset architecture. Connection 902 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 900 includes at least one processing unit (CPU or processor) 904 and connection 902 that couples various system components including system memory 908, such as read-only memory (ROM) 808 and random access memory (RAM) 810 to processor 904. Computing system 900 can include a cache of high-speed memory 706 connected directly with, in close proximity to, or integrated as part of processor 904. Processor 904 may essentially be a completely self-contained computing system, containing multiple cores or processors, a bus, memory controller, cache, etc. A multi-core processor may be symmetric or asymmetric.

Processor 904 can include any general purpose processor and a hardware service or software service, such as services 916, 918, and 720 stored in storage device 914, configured to control processor 904 as well as a special-purpose processor where software instructions are incorporated into the actual processor design. Service 1 916 can be identifying the extent of a flow between the respective panels, for example. Service 2 918 can include segmenting the each of the panels into segmented elements (e.g., background, foreground, characters, objects, text bubbles, text blocks, etc.) and identifying the content of the each of the segmented elements. Service 3 920 can be identifying candidate products to be promoted in the segmented elements, and then selecting from among the candidate products and segmented elements which elements are to be modified to promote which selected products. Additional services that are not shown can include modifying the selected elements to promote the selected products, and integrating the modified elements into the graphic narrative.

To enable user interaction, computing system 900 includes an input device 926, which can represent any number of input mechanisms, such as a microphone for speech, a touch-sensitive screen for gesture or graphical input, keyboard, mouse, motion input, speech, etc. Computing system 900 can also include output device 922, which can be one or more of a number of output mechanisms known to those of skill in the art. In some instances, multimodal systems can enable a user to provide multiple types of input/output to communicate with computing system 900. Computing system 900 can include a communication interface 924, which can generally govern and manage the user input and system output. There is no restriction on operating on any particular hardware arrangement, and therefore the basic features here may easily be substituted for improved hardware or firmware arrangements as they are developed.

Storage device 914 can be a non-volatile memory device and can be a hard disk or other types of computer-readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 914 can include software services, servers, services, etc., that when the code that defines such software is executed by the processor 904, it causes the system to perform a function. In some embodiments, a hardware service that performs a particular function can include the software component stored in a computer-readable medium in connection with the necessary hardware components, such as processor 904, connection 902, output device 922, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a system 400 and perform one or more functions of the method 500 when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, For example, instructions and data which cause or otherwise configure a general purpose computer, special purpose computer, or special purpose processing device to perform a certain function or group of functions. Portions of computer resources used can be accessible over a network. The computer executable instructions may be, For example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method of generating a moving picture from a graphic narrative, comprising:
partitioning one or more pages of a graphic narrative into panels;
segmenting one or more panels of the panels into segmented elements comprising one or more image segments and one or more text segments;
applying the segmented elements to a first machine learning (ML) method to determine labels of the segmented elements;
generating prompts from the labels, the image segments, and the text segments, the prompts representing script information, storyboard information, or scene information corresponding to the one or more panels; and
applying the prompts to a second ML model, and, in response to the prompts, the second ML model outputs a moving picture representing the one or more panels.

2. The method of claim 1, further comprising:
displaying, on a display of a user device, the moving picture in the one or more panels of a digital version of the graphic narrative.

3. The method of claim 1, wherein:
the prompts include an instruction to render the moving picture as either a live-action moving picture or as an animated moving picture of a specified animation style, and
the second ML model outputs the moving picture as the live-action moving picture when the instruction is to render the moving picture as the live-action moving picture, and
the second ML model outputs the moving picture as the animated moving picture of the specified animation style when the instruction is to render the moving picture as the animated moving picture.

4. The method of claim 1, wherein:
the labels of the image segments include image information comprising:
indicia of which of the image segments are foreground elements and background elements,
indicia for how one or more of the image segments move, and/or
indicia of textures and/or light reflection of one or more of the image segments; the labels of the text segments include text information comprising:
indicia of whether one or more of the text segments are dialogue, character thoughts, sounds, or narration, and/or
indicia of a source/origin of the one or more of the text segments; and
the prompts include one or more keyframing instructions and one or more stage commands based on the image information and the text information.

5. The method of claim 4, wherein
the one or more keyframing instructions comprise: (i) an instruction directing the generation of keyframes at intervals throughout the moving picture, wherein the keyframes include at least positions of the image segments in a starting frame and position of the image segments in a concluding frame; (ii) an instruction regarding how the one or more of the foreground elements move between the keyframes; and/or (iii) an instruction regarding how the one or more of the background elements move between the keyframes; and
one or more stage commands comprise: (i) an instruction directing a pace of the moving picture; (ii) a script of dialogue between one or more characters of the moving picture; (iii) an instruction regarding emotions emoted by the one or more characters; (iv) an instruction regarding a tome/mood conveyed by the moving picture; and/or (v) an instruction regarding one or more plot devices to apply in the moving picture.

6. The method of claim 1, wherein the labels comprise:
first text labels indicating which of the text segments include onomatopoeia, narration, or dialogue,
second text labels indicating, for respective dialogue segments of the text segments, a source of a dialogue segment and a tone of the dialogue segment; and/or
first image labels indicating, for respective characters of the image segments, a name of a character represented in a character image segment.

7. The method of claim 1, further comprising:
generating global information of the graphic narrative based on applying the panels to a third ML model, wherein the global information comprises plot information, genre information, and atmospheric information.

8. The method of claim 7, wherein
the plot information comprises a type of plot; plot elements associated with respective portions of the panels; and pacing information associated with the respective portions of the panels;
the genre information comprises a genre of the graphic narrative; and
the atmospheric information comprises settings and atmospheres associated with the respective portions of the panels.

9. The method of claim 8, wherein:
the type of the plot comprises one or more of an overcoming-the-monster plot; a rags-to-riches plot; a quest plot; a voyage-and-return plot; a comedy plot; a tragedy plot; or a rebirth plot;
the plot elements comprise two or more of exposition, a conflict, rising action, falling action, and a resolution;
the genre comprises one or more of an action genre; an adventure genre; a comedy genre; a crime and mystery genre; a procedural genre, a death game genre; a drama genre; a fantasy genre; a historical genre; a horror genre; a mystery genre; a romance genre; a satire genre, a science fiction genre; a superhero genre; a cyberpunk genre; a speculative genre; a thriller genre; or a western genre;
the settings comprise one or more of an urban setting, a rural setting, a nature setting, a haunted setting, a war setting, an outer-space setting, a fantasy setting, a hospital setting, an educational setting, a festival setting, a historical setting, a forest, a dessert, a beach, a water setting, a travel setting, or an amusement-park setting; and
the atmospheres comprise one or more of a reflective atmosphere; a gloomy atmosphere; a humorous atmosphere; a melancholy atmosphere; an idyllic atmosphere; a whimsical atmosphere; a romantic atmosphere; a mysterious atmosphere; an ominous atmosphere; a calm atmosphere; a lighthearted atmosphere; a hopeful atmosphere; an angry atmosphere; a fearful atmosphere; a tense atmosphere; or a lonely atmosphere.

10. The method of claim 1, further comprising:
segmenting, for each respective panel of the panels, a respective panel into respective elements comprising image segments and text segments;
applying the respective elements of the respective panels to a third ML model to predict a narrative flow, the narrative flow comprising an order in which the panels are to be viewed; and
assigning, in accordance with the narrative flow, index values to the respective panels, the index values representing positions in an ordered list that corresponds to the narrative flow.

11. The method of claim 10, further comprising:
generating, based on the respective elements, additional prompts corresponding to the respective panels;
applying the additional prompts to the second ML model and in response outputting additional moving pictures corresponding to the respective panels; and
integrating, based on the narrative flow, the moving picture and the additional moving pictures to generate a film of the graphic narrative.

12. The method of claim 10, wherein
the first ML model uses information from neighboring frames to a frame to provide continuity and/or coherence between the moving picture of the frame and moving pictures of the neighboring frames.

13. The method of claim 10, wherein determining the prompt of a frame is based on local information derived from the frame and global information based on an entirety of the graphic narrative.

14. The method of claim 1, further comprising:
ingesting the graphic narrative;
slicing the graphic narrative into respective pages and determining an order of the pages;
applying information of panels on a given page to a third ML model to predict a page flow among the panels of the given page, the predicted page flow comprising an order in which the panels are to be viewed;
determining a narrative flow based on the order of the pages and the page flow, wherein panels on a page earlier in the order of the pages occur earlier in the narrative flow than panels on a page that is later in the order of the pages; and
displaying, on a display of a user device, the panels according to the predicted order in which the panels are to be viewed, wherein the moving picture is displayed in association with the one or more panels.

15. The method of claim 1, further comprising:
generating a title sequence of the graphic narrative, wherein the title sequence is a moving picture, and the title sequence is generated based on parsing text segments on a title page and printing page of the graphic narrative, and determining therefrom contributor and contributions ascribed to the respective contributors.

16. The method of claim 1, wherein segmenting the one or more panels into the segmented elements is performed using a semantic segmentation that is selected from the group consisting of a Fully Convolutional Network (FCN) model, a U-Net model, a SegNet model, a Pyramid Scene Parsing Network (PSPNet) model, a DeepLab model, a Mask R-CNN, an Object Detection and Segmentation model, a fast R-CNN model, a faster R-CNN model, a You Only Look Once (YOLO) model, a fast R-CNN model, a PASCAL VOC model, a COCO model, a ILSVRC model, a Single Shot Detection (SSD) model, a Single Shot MultiBox Detector model, and a Vision Transformer, ViT) model.

17. The method of claim 1, wherein
the first ML model used for determining the labels of the segmented elements includes an image classifier and a language model;
the image classifier is selected from the group consisting of a K-means model, an Iterative Self-Organizing Data Analysis Technique (ISODATA) model, a YOLO model. A ResNet model, a ViT model, a Contrastive Language-Image Pre-Training (CLIP) model, a convolutional neural network (CNN) model, a MobileNet model, and an EfficientNet model; and
the language model is selected from the group consisting of a transformer model, a Generative pre-trained transformers (GPT), a Bidirectional Encoder Representations from Transformers (BERT) model, and a T5 model.

18. The method of claim 1, wherein
the second ML model used for outputting the moving picture representing the one or more panels includes an art generation model selected from the group consisting of a generative adversarial network (GAN) model; a Stable Diffusion model; a DALL-E Model; a Craiyon model; a Deep AI model; a Runaway AI model; a Colossyan AI model; a DeepBrain AI model;
a Synthesia.io model; a Flexiclip model; a Pictory model; a In Video.io model; a Lumen5 model; and a Designs.ai Videomaker model.

19. A computing apparatus comprising:
a processor; and
a memory storing instructions that, when executed by the processor, configure the apparatus to:
partition one or more pages of a graphic narrative into panels;
segment one or more panels of the panels into segmented elements comprising one or more image segments and one or more text segments;
apply the segmented elements to a first machine learning (ML) method to determine labels of the segmented elements;
generate prompts from the labels, the image segments, and the text segments, the prompts representing script information, storyboard information, or scene information corresponding to the one or more panels; and
apply the prompts to a second ML model, and, in response to the prompts, the second ML model outputs a moving picture representing the one or more panels.

20. The computing apparatus of claim 19, wherein:
the labels of the image segments include image information comprising:
indicia of which of the image segments are foreground elements and background elements,
indicia for how one or more of the image segments move, and/or
indicia of textures and/or light reflection of one or more of the image segments;
the labels of the text segments include text information comprising:
indicia of whether one or more of the text segments are dialogue, character thoughts, sounds, or narration, and/or
indicia of a source/origin of the one or more of the text segments; and
the prompts include one or more keyframing instructions and one or more stage commands based on the image information and the text information.
